(19) United States
(12) Patent Application Publication
(10) Pub. No.: US 2026/0348743 A1
(43) Pub. Date: Nov. 5, 2026

(54) PRINTED CIRCUIT BOARD ANVIL ANGLE SENSOR SYSTEM

(71) Applicant: Ingersoll-Rand Industrial U.S., Inc., Davidson, NC (US)

(72) Inventors: Mark T McClung, Byram Township, NJ (US); Timothy Cooper, Titusville, NJ (US)

(21) Appl. No.: 19/665,601

(22) Filed: May 1, 2026

Related U.S. Application Data
(60) Provisional application No. 63/798,908, filed on May 2, 2025.

(51) Int. Cl. G01D 5/20; B25B 21/02; B25F 5/00

(52) U.S. Cl. CPC G01D 5/2013; B25B 21/02; B25F 5/001

(57) ABSTRACT

A PCB angle sensor system for a rotary power tool. The power tool includes a housing holding an impact mechanism including an anvil having a longitudinally extending shaft and a plurality of anvil jaws extending from the shaft, and a hammer driven by a gear train to apply a rotational impact force on the anvil. The PCB angle sensor system includes a target disk disposed on the shaft including at least one substrate layer and a metallic target portion, where the metallic target portion is at least partially deposited onto the at least one substrate layer, and an inductive sensor attached to an inner circumferential surface of the hammercase. The inductive sensor is configured to read and interpret voltage signal variations produced by the metallic target portion as the metallic target portion rotates with the anvil and determine the position of the anvil and/or shaft.

### BACKGROUND

A rotary tool, such as an impact wrench, generally includes a housing or hammercase supporting a drive mechanism, an output shaft having a first end configured to engage a fastener and a second end having an anvil, and a drive mechanism operable to drive the output shaft. Generally, the operator operates the tool in a forward direction to thread the fastener into engagement with a workpiece, and in a reverse direction to unthread the fastener from the workpiece. Other rotary tools may include the drive mechanism operable to drive a gearbox that drives the output shaft.

### DRAWINGS

The Detailed Description is described with reference to the accompanying figures. The use of the same reference numbers in different instances in the description and the figures may indicate similar or identical items.

FIG. 1 is a partial cross-sectional side view illustrating a rotary power tool assembly having an angle sensor system in accordance with example embodiments of the present disclosure.

FIG. 2 is a cross-sectional side view of the angle sensor system of FIG. 1, having a target disk and an angle sensor, in accordance with example embodiments of the present disclosure.

FIG. 3 is a front view of the target of FIG. 2, in accordance with example embodiments of the present disclosure.

FIG. 4 is a cross-sectional front view of the angle sensor, as shown in FIG. 2, in accordance with example embodiments of the present disclosure.

FIG. 5 is a cross-sectional side view of the angle sensor, as shown in FIG. 2, in accordance with example embodiments of the present disclosure.

FIG. 6 is a front view of an unwrapped angle sensor, such as the one shown in FIG. 5, in accordance with example embodiments of the present disclosure.

FIG. 7 is a front view of the target disk of FIG. 2, in accordance with example embodiments of the present disclosure.

FIGS. 8A-8D are front views of layers of the target disk of FIG. 7, in accordance with example embodiments of the present disclosure.

FIG. 9 is a control system in communication with the rotary power tool in accordance with example embodiments of the present disclosure.

FIG. 10 is a cross-sectional side view of an angle sensor system having a target disk and an angle sensor, in accordance with example embodiments of the present disclosure.

### DETAILED DESCRIPTION

For the purposes of promoting an understanding of the principles of the subject matter, reference will now be made to the embodiments illustrated in the drawings and specific language will be used to describe the same. It will nevertheless be understood that no limitation of the scope of the subject matter is thereby intended. Any alterations and further modifications in the described embodiments, and any further applications of the principles of the subject matter as described herein are contemplated as would normally occur to one skilled in the art to which the subject matter relates.

### Overview

Rotary power tools (e.g., impact tools, impulse tools, or other rotary output tools) may be configured to deliver torque to an output element while reducing the exertion by a user. In some implementations, a rotating mass (e.g., a hammer or other inertia-storing element) may store energy and intermittently transfer the stored energy to an output member (e.g., an anvil or output shaft), subjecting the output member to repeated or transient loading conditions. As the rotating mass drives the output member, it may be desirable to determine an angular velocity, angular position, or rotational state of the output member.

Conventional rotary power tools may include a sensor and a target portion sensed by the sensor, where the target portion is coupled to a rotating output member. In certain designs, the target portion may be integrally formed with the output member or another element connected therewith (e.g., with an anvil). Coupling a target portion directly to an output member that experiences high loads, impacts, or rapid torque fluctuations may present limitations. For example, material selection for the target portion may be constrained by mechanical loading requirements, which may adversely affect sensing performance. Additionally, such target portions may be relatively bulky to withstand operating conditions, increasing rotational inertia, and may increase manufacturing complexity and cost.

Accordingly, the present disclosure is directed to a rotary power tool, for example, an impact tool, including a printed circuit board (PCB) angle sensor system employing an angle sensor that is separate from the anvil of the power tool, the angle sensor disposed on an inner surface of a housing of the power tool. The PCB angle sensor system comprises a target disk, fixedly coupled to the anvil but formed from a different material than the anvil. For example, in embodiments, the PCB angle sensor may be formed of a non-metallic substrate that improves the inductive properties of target portions defined on the target disk, minimizing the target disk inertia (allowing faster changes in speed, direction, etc.), and minimizing the manufacturing costs associated with the manufacturing of the anvil.

The PCB angle sensor system may be used in conjunction with a control system to process rotational information associated with the output member and to support tool control functions. In some implementations, the control system may use the sensed rotational information to determine a desired operational condition and may control operation of the rotary power tool based on the determination.

As used herein, the term “output member” refers generally to any rotatable component of a rotary power tool that is driven, directly or indirectly, by a drive mechanism and configured to transmit rotational motion for performing work. The output member may include, for example, a shaft, spindle, rotor, anvil, or another rotary element coupled to a gear train, transmission, or drive assembly. In some embodiments, the output member comprises an anvil of an impact mechanism, while in other embodiments the output member comprises a rotor or output shaft of a non-impact rotary power tool. The output member may be formed as a single integral component or as multiple coupled components that rotate together about a common axis. References herein to a “shaft” include any portion of an output member configured to rotate about an axis and to which a target disk, sensing element, or other rotationally indexed component may be coupled.

### DETAILED DESCRIPTION OF EXAMPLE EMBODIMENTS

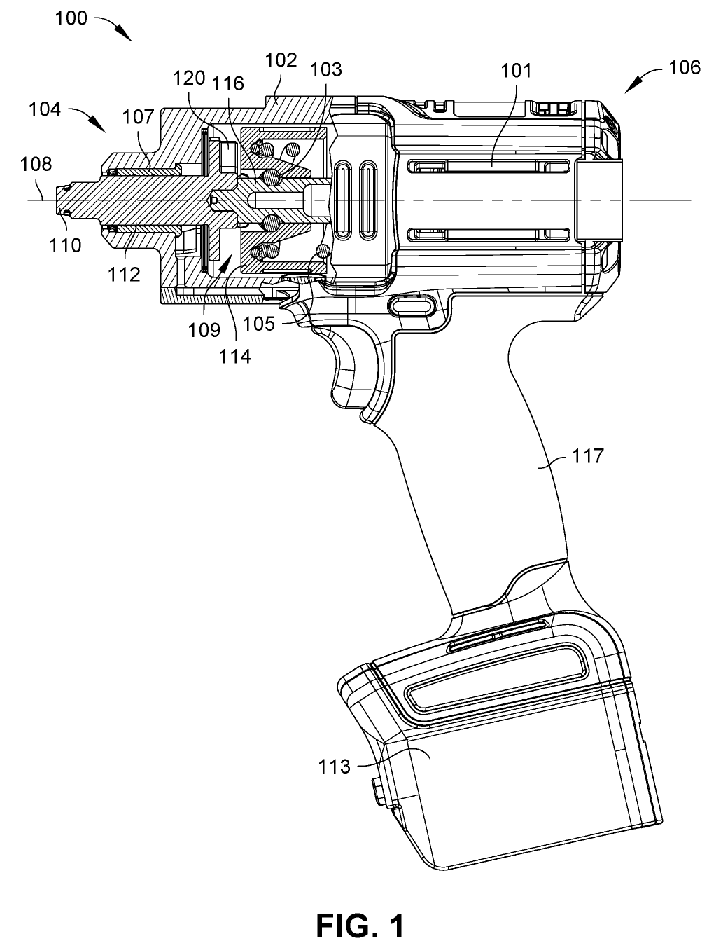

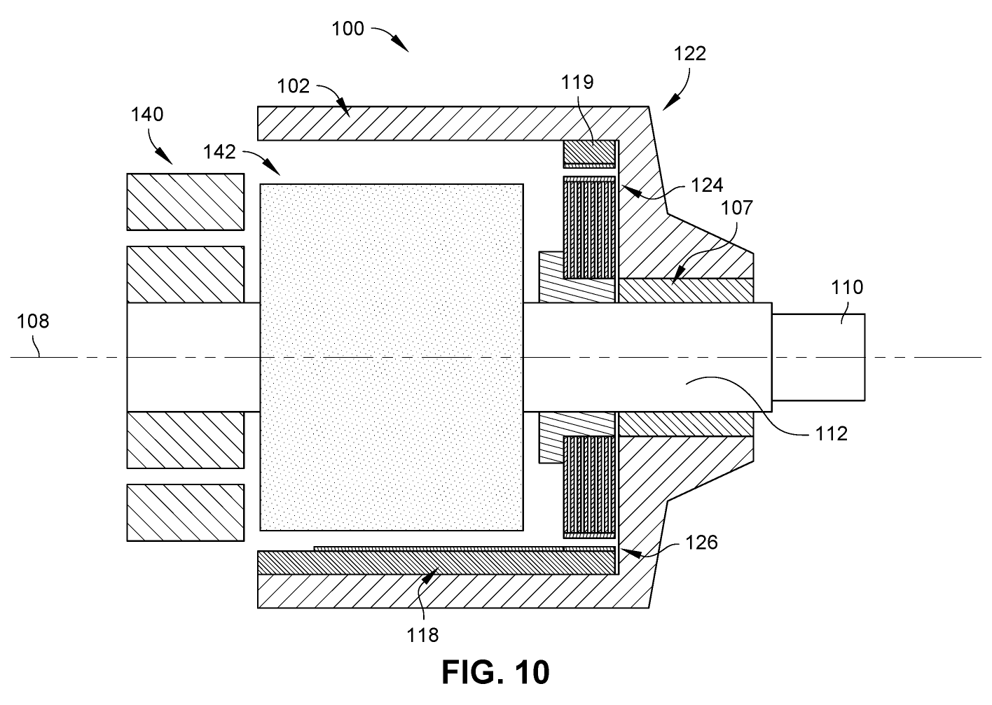

FIG. 1 shows an illustrative embodiment of a rotary power tool assembly 100 in accordance with the present disclosure. As shown, the rotary power tool assembly 100 includes a housing (e.g., a hammercase) 102 having a forward end 104 and a rearward end 106. The housing 102 houses an impact mechanism 109. The impact mechanism 109 is coupled to a drive train 101 including a motor which actuates a planetary gear set assembly 142 (see FIG. 10). The drive train 101 drives the impact mechanism 109. The impact mechanism 109 includes a camshaft 116, a hammer 114, and a cam ball 103 that engages both the cam shaft 116 and the hammer 114. The cam shaft 116 is rotated relative to the hammer 114. Following the action of a helical cam of the cam shaft 116, the hammer 114 is pulled axially, hits an anvil jaw 120 of an anvil 112 and rotates forward again about an output axis 108. After the hammer 114 impacts the anvil 112, causing the anvil 112 to rotate, the hammer 114 rebounds, or bounces backward, and axially rides up the cam while the camshaft 116 continues to rotate forward, making the hammer 114 to pass over the anvil jaws 120. Repeating this process results in the hammer 114 making continuous intermittent impacts against the anvil 112 causing the anvil 112 to continually rotate. In embodiments, the power tool assembly 100 includes a bushing 107 configured to act as a bearing surface to the anvil 112. An output shaft 110 extends from the anvil 112 along the axis 108 and may receive a connector or other device that engages a fastener (e.g., a bolt, a nut, a screw, etc.) to be tightened or loosened.

In embodiments, the housing 102 employs a pistol design wherein a handle 117 provides a pistol-type grip that is generally perpendicular to the output axis 108. In other embodiments, the handle 117 may be parallel to (e.g., coaxial with) the output axis 108. In embodiments, the drive train 101 and/or the impact mechanism 109 may be parallel to (e.g., coaxial with) the output axis 108. In other embodiments, the drive train 101 and/or the impact mechanism 109 may be generally perpendicular to the output axis 108.

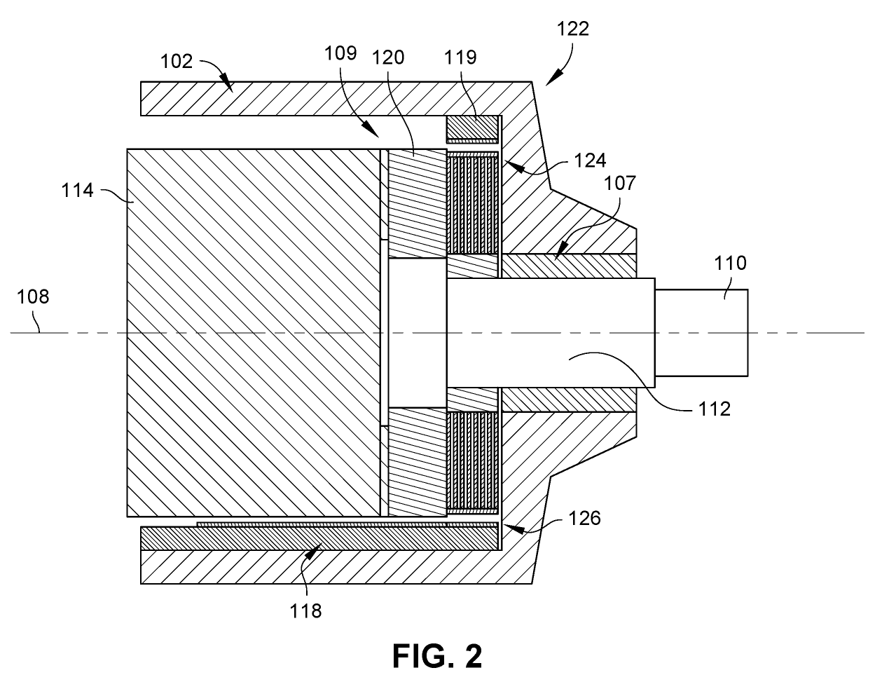

In the embodiment illustrated in FIGS. 1 and 2, the power tool assembly 100 comprises an impact wrench. However, those of skill in the art will understand that the power tool assembly 100 is not limited to an impact wrench and that a variety of different elements may be used. For example, other power tools suitable for use by the power tool assembly 100 can include fastening tools used for fastening and unfastening threaded fasteners such as, but not limited to, impact drivers, nut runner tools, pulse wrenches, grinders, drills, combination hammers, screwdrivers, clutch tools, and so forth that include a rotor driven by a drive train. In embodiments, as shown in FIG. 10, power tool assembly 100 includes a motor 140 driving a gearbox 142 coupled to the output shaft 110. The motor 140 may be an electric motor powered by a power source 113 such as a removable battery (in the configuration shown in FIG. 1), an internal battery or an external power source via an electric cord. However, it is contemplated that the rotary power tool assembly 102 may also comprise a pneumatic tool having a drive train 101 employing a pneumatic (compressed air) motor powered by a source of compressed air.

In the embodiment shown in FIG. 2, the rotary power tool 100 includes a frame 118 and an angle sensor system 122 inside the housing 102. As shown, the frame 118 is supported by the inner circumferential surface of the housing 102, and is disposed radially facing the hammer 114, and/or the anvil 112. In embodiments, the frame 118 may include a portion formed in the shape of a ring 119, where the ring 119 at least partially surrounds the anvil 112 and at least partially surrounds and/or supports the angle sensor system 122. The frame 118 may be integral with or separate from the housing 102. In embodiments where the rotary power tool 100 is a power tool that does not include an anvil, the angle sensor system 122 may be an angle sensor system 122 configured to determine a position of the output shaft 110 of the rotary power tool 100 about the output axis 108.

The angle sensor system 122 includes a target disk 124, fixedly coupled to the anvil 112, and an angle sensor 126, attached on an inner surface of the frame 118. In embodiments, the angle sensor 126 comprises an inductive sensor. The inductive sensor includes a microchip 130 and a set of coils comprising a transmitting coil 132 and receiving coils 134. The transmitting coil 132 and the receiving coils 134 may be planar, arcuate, patterned, or a combination thereof.

The microchip is communicatively coupled to the transmitting coil 132 and the receiving coils 134 to transmit and receive information from the relative rotation of the target disk 124 as sensed by the set of coils. In embodiments, the microchip 130 is disposed on a printed circuit board (PCB) 128 coupled to the inner surface of the frame 118. The transmitting coil 132 and the receiving coils 134 may have a shape that conforms to the dimensions of the target disk 124 attached to the anvil 112.

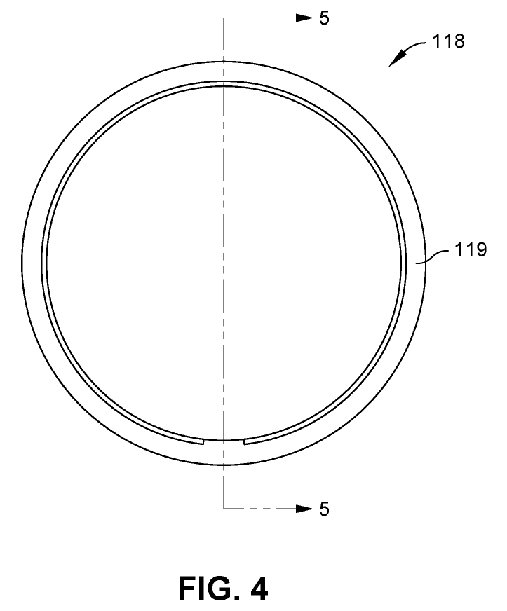

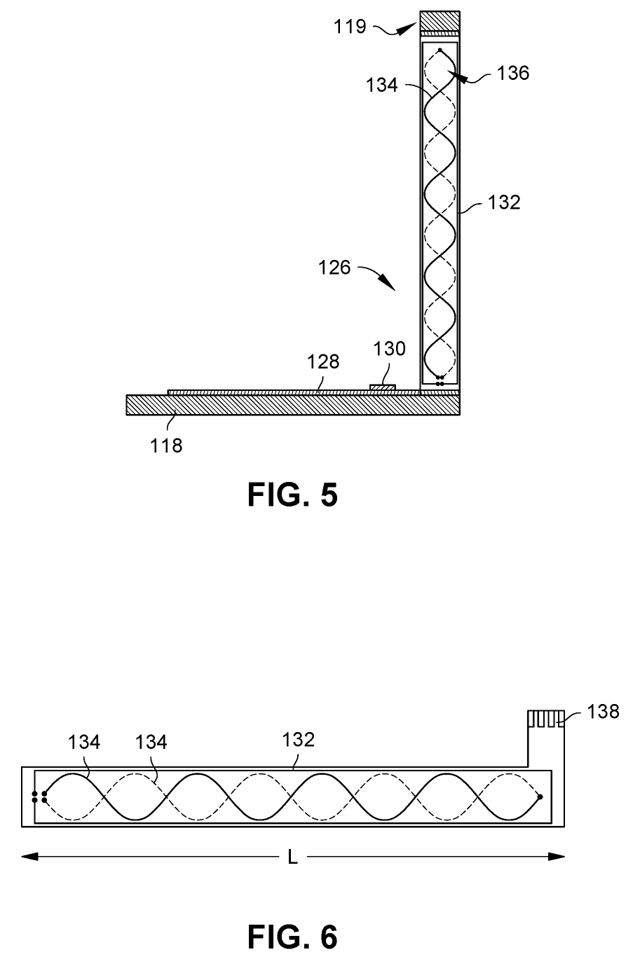

In the embodiments shown in FIGS. 4 through 6, the transmitting coil 132 and the receiving coils 134 are disposed on a flexible circuit board 136 coupled to the PCB 128 through a coupling circuit 138. The flexible circuit board 136 may be fixed on an inner surface of the ring 119 and facing the target disk 124. The frame 118 and the ring 119 separate and shield the transmitting coil 132 and the receiving coils 134 from the housing 102. In other embodiments, the flexible circuit board 136 having the transmitting coil 132 and the receiving coils 134 may be disposed axially facing the target disk 124. In such embodiments, the flexible circuit board 136 may have a different shape than as shown in FIG. 6. For example, the flexible circuit board 136 may form a curved shape, including but not limited to a circle (not shown). In still other embodiments, the flexible circuit board 136 may be at least partially disposed radially facing the target disk 124 and at least partially disposed axially facing the target disk 124.

As shown in FIG. 2, the receiving coils 134 of the angle sensor 126 may be positioned in a close and generally fixed proximity to the centerline and/or the face of the target disk 124, whether the target disk 124 is sensed axially or radially. In embodiments, the receiving coils 134 are disposed in an arc shape to sense the radial edge of the target disk 124. In this manner, the proximity of the coils to the outer diameter of the target disk 124 may be better controlled than the proximity of the receiving coils 134 to the axial face of the target disk 124. In other embodiments, the transmitting coil 132 and the receiving coils 134 are disposed on a plurality of PCB layers 123 stacked axially, the plurality of PCB layers 123 radially facing the target disk 124.

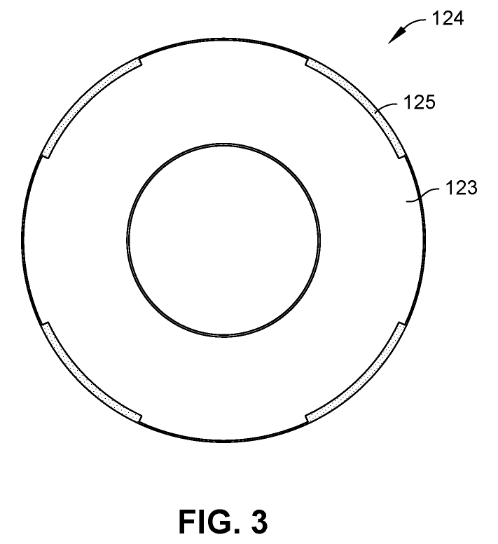

As shown in FIGS. 2 and 3, the target disk 124 may comprise a plurality of PCB layers 123 formed from a non-metallic substrate. The multilayer target disk 124 may have metallic target portions 125 disposed in a specific shape and deposited or otherwise attached to the non-metallic substrate. The non-metallic substrate may be composed of at least one polymer and/or at least one ceramic, or a combination thereof. The resulting multilayer target disk 124 produces a voltage signal that varies with the location and amount of surface area of the receiving coils 134 that is "blocked" or covered by the metallic target portions 125 as the anvil 112 rotates about the output axis 108. As the target disk 124 rotates, the signal from the inductive sensor 130 varies with the angle of turn of the target disk 124 in a predictable manner that can be calibrated to indicate the anvil 112 angle position.

In embodiments, metallic target portions 125 of the plurality of PCB layers 123 are deposited in a desired geometry onto the non-metallic substrate. For example, a conductive metal, such as but not limited to copper, tin, lead, iron, nickel, silver, palladium, and/or gold, or a combination thereof, may be deposited onto the non-metallic substrate in thin layers. In some embodiments, the conductive metal(s) may be deposited onto the plurality of PCB layers 123 in alternating layers. For example, as shown in FIGS. 8A through 8D, subsequent layers of the plurality of PCB layers 123 may have progressively larger and/or smaller arc traces deposited onto each layer 123. The stacked plurality of PCB layers 123 forming the target disk 124, though thin and separate, in combination with each other, may produce a desired shape, amount and/or be deposited in a desired location to form the metallic target portions 125. The metallic target portions 125 may be stacked in radial and/or axial directions around output axis 108.

In embodiments, the metallic target portions 125 of the target disk 124 are uniform in radial thickness and have a constant angular pattern around the edges of the plurality of PCB layers 123. For example, the metallic target portions 125 may be disposed perpendicular to the receiving coils 134 and comprise identical arcuate strips on the periphery of the plurality of PCB layers 123. In other embodiments, the metallic target portions 125 could also be formed on the plurality of PCB layers 123 using edge plating in the same regular angular pattern to create surfaces that are parallel to the receiving coils 134 (See FIG. 3) rather than perpendicular to the receiving coils 134.

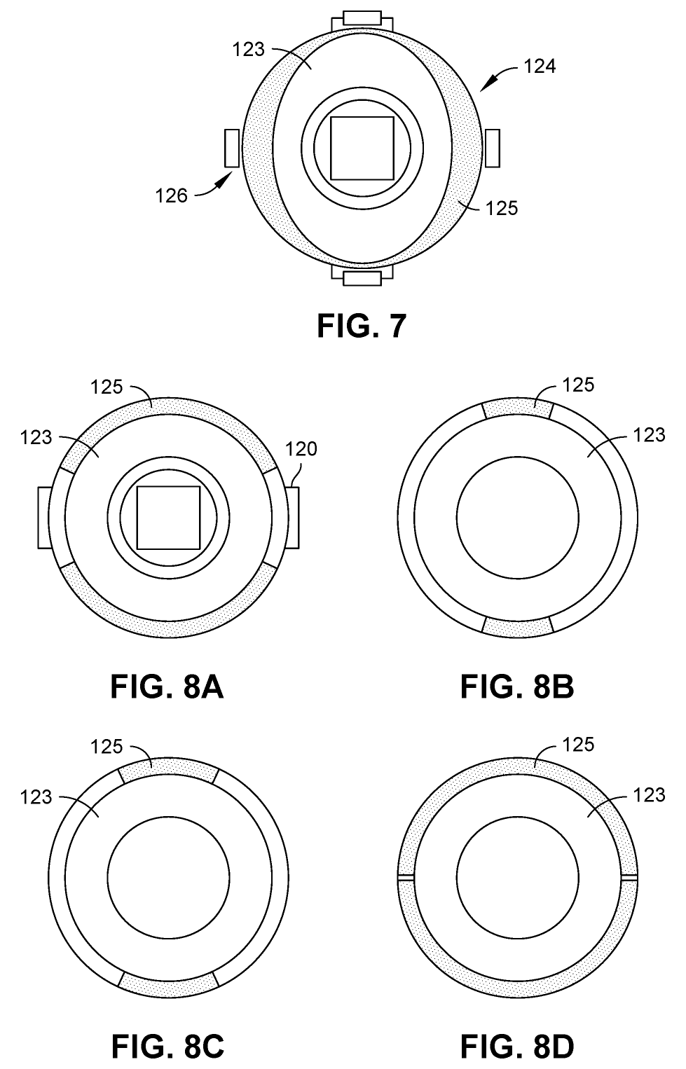

In other embodiments, the geometry of the metallic target portions 125 may vary in each layer of the plurality of PCB layers 123 to form the predetermined shape (in the desired radial and or axial location within the target disk 124) of the metallic target "blockage." (e.g., the surface of the target disk 124 that is covered by the metallic target portions 125). For example, this geometry could include a constant radial width arcuate strip of varying sweep angle on each layer (See FIGS. 8A through 8D), where the arcuate strip is deposited on an outer edge of the face of the target disk 124. In other embodiments, the metallic target portions 125 may have a common geometry on all layers of the plurality of PCB layers 123 that varies in radial width with a sweep angle (See FIG. 7).

In embodiments, the geometry of the metallic target portions 125 may be different depending on whether target disk 124 is axially or radially sensed with the receiving coils 134 of the flexible circuit board 136. However, the signal produced by the variation of the amount of metal deposited and the angular location of the metal deposited is a defined and calibratable relationship. For example, in embodiments where the target disk 124 is axially sensed, the metallic target portion 125 is positioned on the face of the target disk 124 and not on the edge of the target disk 124. In this embodiment, the target disk 124 may have one (1) PCB layer 123 having metallic target portions 125 deposited on the face of the target disk 124. In other embodiments having an axially sensed target disk 124, more than one (1) PCB layer 123 having metallic target portions 125 deposited on the face of the target disk 124 may be used. Different embodiments of the axially sensed metallic target portions 125 and the radially sensed metallic target portions 125 may have different lengths, shapes, and/or thicknesses. In embodiments, the lengths, shapes, and/or thicknesses of the different metallic target portions 125 deposited on the plurality of PCB layers 123 may vary between each of the plurality of PCB layers 123.

In embodiments (not shown), the target disk 124 is attached to the anvil 112 using a hex, a spline, an involute spline, a square, a stub tooth spline, square teeth, arc teeth, radial slots, tri-lobes, hex indents, keys, keyways, and/or another non-circular geometry that increases the friction between the target disk 124 and the anvil 112. In embodiments, the target disk 124 may be attached to the output shaft 110 or anvil 112 with or without an adhesive configured to maintain a defined, fixed and rigid angular orientation of the target disk 124 with the output shaft 110 of the anvil 112.

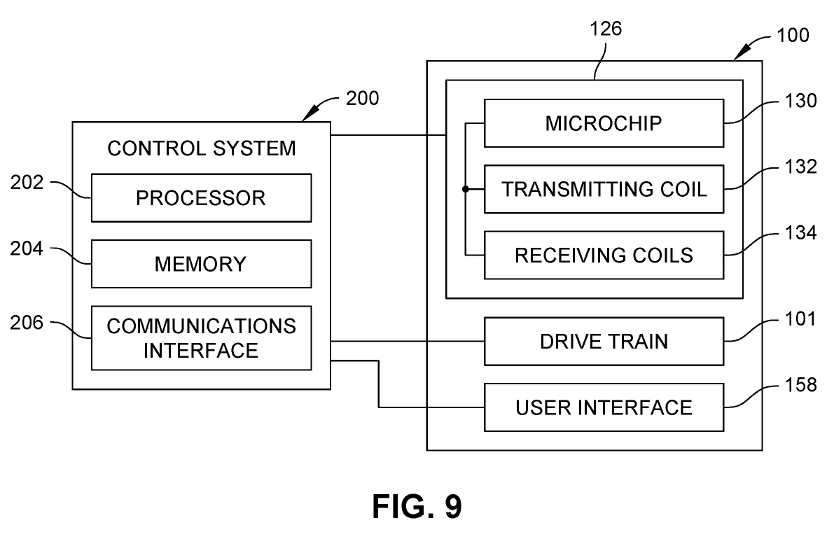

Referring to FIG. 9, the rotary power tool assembly 100 may be coupled with a control system 200 for controlling operation of the rotary power tool assembly 100. For example, the control system 200 may be configured to control rotation of the output shaft 110. The control system 200 may include one or more processors 202, one or more memory devices 204, and a communications interface 206. The control system 200 may be in communication with the drive train 101 to control actuation of the drive train 101 and, in some embodiments, an impact mechanism 109. Additionally, the control system 200 may receive information from the angle sensor system 122 (e.g., from the angle sensor 126) and may adjust operating characteristics of the rotary power tool assembly 100, including adjusting speed or stopping operation of the drive train 101, based on the received information. In embodiments, the control system 200 limits, throttles, or logically controls one or more of power, torque, or speed based on one or more operational settings stored in memory 204 of the rotary power tool assembly 100 or stored in memory associated with a remote server computer operatively coupled with the control system 200.

The processor 202 provides processing functionality for the control system 200 and may include one or more processors, microcontrollers, or other processing devices, implemented using semiconductor devices and electronic integrated circuit components. The processor 202 may execute software, firmware, or other program instructions to implement control techniques described herein.

The memory 204 comprises one or more non-transitory computer-readable storage media configured to store data associated with operation of the control system 200. Such data may include software programs, firmware, configuration settings, calibration data, and other information used to control operation of the rotary power tool assembly 100 and its components. The memory 204 may be integrated with the processor 202, provided as a separate storage component, or implemented as a combination thereof. A variety of memory types may be used, including volatile and non-volatile memory.

In some embodiments, the memory 204 may include removable or non-removable memory elements, such as RAM, ROM, flash memory, or other electronic storage media. The memory 204 may also store operational parameters and tool control settings associated with the rotary power tool assembly 100 and executable instructions used by the processor 202 to perform the control functions described herein.

The control system 200 includes a communications interface 206 configured to facilitate communication between components of the control system 200 and between the control system 200 and one or more external devices. The communications interface 206 may support wired or wireless communication and may enable data exchange with a remote server, user interface 158, or other external system. For example, the control system 200 may communicate with an external server to exchange data associated with operation or configuration of the rotary power tool assembly 100 based on information received from the angle sensor system 122. The control system 200 may further be coupled to one or more input/output devices, including displays, touchscreens, speakers, or control buttons.

The control setting of the rotary power tool assembly 100 can include a stored an operational setting for the rotary power tool assembly 100, which can direct tool operations by controlling settings including, but not limited to, rotation direction, speed, reverse speed, acceleration, torque, torque limit, cycle timeout, trace data information, step type (e.g., target angle, target torque, etc.), or the like, or combinations thereof, and other information that is useful to an operator of the rotary power tool assembly 100 during operation, setup, and so on. The user may interact with the user interface 158 to engage and edit the operational settings of the rotary power tool assembly 100

The embodiment illustrated in FIG. 10 and other example embodiments not shown generally corresponds to and may implement the same principles, structures, and operational features described above with respect to the embodiments shown in FIGS. 1 and 2. In particular, the configuration of the angle sensor system 122, including the coupling of a target disk 124 to a rotating output shaft 110 and the positioning of an inductive sensor on an inner circumferential surface of a housing or frame, may be the same as or similar to the configurations described in connection with FIGS. 1 and 2. The embodiment of FIG. 10 may differ primarily in the relative orientation or placement of the sensor components or target disk 124, such as by sensing rotation in the axial direction rather than the radial direction, or by employing a different mounting arrangement within the housing. For example, the frame 118 may be supported by an axial end wall within the housing 102, proximate to the forward end 104. Unless expressly stated otherwise, the materials, control system interactions, signal processing, and functional operation described with respect to FIGS. 1 and 2 are equally applicable to the embodiment shown in FIG. 10.

While the subject matter has been illustrated and described in detail in the drawings and foregoing description, the same is to be considered as illustrative and not restrictive in character, it being understood that only example embodiments have been shown and described and that all changes and modifications that come within the spirit of the subject matters are desired to be protected. In reading the claims, it is intended that when words such as “a,” “an,” “at least one,” or “one of a plurality of” are used there is no intention to limit the claim to only one item unless specifically stated to the contrary in the claim. Unless specified or limited otherwise, the terms “mounted,” “coupled,” “fixed,” “supported,” and “connected” and variations thereof are used broadly and encompass both direct and indirect mountings, connections, and couplings. Further, "connected" is not restricted to physical or mechanical connections or couplings.

What is claimed is:

1. A rotary power tool assembly comprising:
a hammercase having a forward end and a rearward end and defining an axis extending between the forward end and the rearward end;
an impact mechanism housed within the hammercase, the impact mechanism including:
an anvil including a longitudinally extending shaft and a plurality of anvil jaws extending from the shaft, the anvil rotatable about the axis;
a hammer configured to apply a rotational impact force on the anvil; and
an anvil angle sensor system, the anvil angle sensor system comprising:
a target disk disposed on the anvil proximate to the forward end of the hammercase, the target disk including at least one substrate layer and a metallic target portion, the metallic target portion at least partially deposited onto the at least one substrate layer; and
an inductive sensor supported by an inner circumferential surface of the hammercase;
wherein the inductive sensor is configured to read and interpret voltage signal variations produced by the metallic target portion as the metallic target portion rotates with the anvil, the inductive sensor configured to generate voltage signal variations corresponding to rotational position of the anvil rotating about the axis.

2. The rotary power tool assembly of claim 1, wherein the inductive sensor comprises a flexible circuit at least partially disposed around the target disk, the flexible circuit including at least one coil radially facing the target disk.

3. The rotary power tool assembly of claim 1, wherein the target disk comprises a plurality of substrate layers composed of a non-metallic substrate.

4. The rotary power tool assembly of claim 3, wherein the non-metallic substrate is fiberglass.

5. The rotary power tool assembly of claim 3, wherein the metallic target portion at least partially deposited onto the at least one substrate layer comprises at least one of copper, tin, lead, iron, nickel, silver, palladium, or gold deposited on an edge of at least one of the plurality of substrate layers.

6. The rotary power tool assembly of claim 3, wherein the metallic target portion at least partially deposited onto the at least one substrate layer comprises at least one of copper, tin, lead, iron, nickel, silver, palladium, or gold deposited at an outer edge of a face of at least one of the plurality of substrate layers.

7. The rotary power tool assembly of claim 3, wherein the metallic target portion at least partially deposited onto the at least one substrate layer comprises at least one of copper, tin, lead, iron, nickel, silver, palladium, or gold, deposited on an edge of at least one of the plurality of substrate layers and at an outer edge of a face of the at least one of the plurality of substrate layers.

8. The rotary power tool assembly of claim 1, wherein the anvil angle sensor operatively coupled with a control system to process the angle of the anvil, determine the angle of the anvil and change a configuration of the rotary power tool assembly based on the angle of the anvil.

9. The rotary power tool assembly of claim 8, wherein the control system shuts off the rotary power tool assembly based on the determined angle of the anvil.

10. An angle sensor system for a rotary power tool, the angle sensor system comprising:
a target disk disposed on a shaft of the rotary power tool, the target disk proximate to a forward end of a tool housing and including at least one substrate layer and a metallic target portion, the metallic target portion at least partially deposited onto the at least one substrate layer; and
an inductive sensor attached to an inner circumferential surface of the tool housing;
wherein the inductive sensor is configured to read and interpret voltage signal variations produced by the metallic target portion as the metallic target portion rotates with the shaft, the inductive sensor determining the position of the target disk rotating about the axis.

11. The angle sensor system of claim 10, wherein the inductive sensor comprises a flexible circuit at least partially disposed around the target disk, the flexible circuit including at least one coil radially facing the target disk.

12. The angle sensor system of claim 10, wherein the target disk comprises a plurality of substrate layers composed of a non-metallic substrate.

13. The angle sensor system of claim 12, wherein the non-metallic substrate is fiberglass.

14. The angle sensor system of claim 10, wherein the metallic target portion at least partially deposited onto the at least one substrate layer comprises at least one of copper, tin, lead, iron, nickel, silver, palladium, or gold deposited on an edge of the at least one substrate layer.

15. The angle sensor system of claim 10, wherein the metallic target portion at least partially deposited onto the at least one substrate layer comprises copper deposited at an outer edge of a face of the at least one substrate layer.

16. The angle sensor system of claim 10, wherein the metallic target portion at least partially deposited onto the at least one substrate layer comprises at least one of copper, tin, lead, iron, nickel, silver, palladium, or gold deposited on an edge of the at least one substrate layer and at an outer edge of a face of the at least substrate layer.

17. A rotary power tool assembly comprising:
a housing having a forward end and a rearward end and defining a tool axis extending between the forward end and the rearward end;
a drive mechanism disposed at least partially within the housing and configured to rotate an output shaft about the tool axis; and
an angle sensor system including:
a target disk fixedly coupled to the output shaft, the target disk including at least one substrate layer and at least one metallic target portion disposed on the at least one substrate layer; and
an inductive sensor supported by an inner circumferential surface of the housing and positioned to face the target disk,
wherein, during rotation of the output shaft, the inductive sensor is configured to generate an electrical signal that varies based on movement of the metallic target portion relative to the inductive sensor, and wherein the angle sensor system is configured to determine an angular position of the output shaft about the tool axis based on the electrical signal.

18. The rotary power tool assembly of claim 17, wherein the inductive sensor comprises a flexible circuit at least partially disposed around the target disk, the flexible circuit including at least one coil radially facing the target disk.

19. The rotary power tool assembly of claim 17, wherein the target disk comprises a plurality of substrate layers composed of a non-metallic substrate.

20. The rotary power tool assembly of claim 19, wherein the metallic target portion comprises at least one of copper, tin, lead, iron, nickel, silver, palladium, or gold deposited on an edge of at least one of the plurality of substrate layers.
